(19) United States
(12) Patent Application Publication
(10) Pub. No.: US 2011/0091044 A1
(43) Pub. Date: Apr. 21, 2011

(54) Virtual speaker apparatus and method for processing virtual speaker

(75) Inventors: Kang Eun Lee, Hwaseong-si (KR); Do-Hyung Kim, Hwaseong-si (KR); Chang Yong Son, Gunpo-si (KR)

(73) Assignee: SAMSUNG ELECTRONICS CO., LTD., Suwon-si (KR)

(21) Appl. No.: 12/805,414

(22) Filed: Jul. 29, 2010

(30) Foreign Application Priority Data
Oct. 15, 2009 (KR) 10-2009-0098072

(51) Int. Cl. H04R 5/04

(52) U.S. Cl. 381/18; 381/17

(57) ABSTRACT

A virtual speaker apparatus and a virtual speaker processing method is disclosed. The virtual speaker apparatus uses the closest surround speaker when a virtual speaker to be virtually generated is a back left virtual speaker or a back right virtual speaker.

### CROSS-REFERENCE TO RELATED APPLICATIONS

This application claims the benefit of Korean Patent Application No. 10-2009-0098072, filed on Oct. 15, 2009, in the Korean Intellectual Property Office, the disclosure of which is incorporated herein by reference.

### BACKGROUND

1. Field

One or more example embodiments relate to a virtual speaker apparatus and a virtual speaker processing method.

2. Description of the Related Art

In the past, audio technology tended to be driven by quality-centric development. However, consumer demand for a reality-centric audio technology steadily increases as the capacity of current systems rapidly increases. Recently, a general audio-play environment has at least one of a stereo speaker system and a 5.1 channel speaker system. However, an existing configuration may lack the capacity to play a number of channels that is greater than a number of channels played by the 5.1 channel system. Thus, a virtual speaker technology that enables a user to experience audio beyond the capabilities of the 5.1 channel system through the 5.1 channel system has been developed.

### SUMMARY

According to example embodiments of the present disclosure, a virtual speaker apparatus may be provided. The virtual speaker apparatus includes a first adder to add a first virtual channel signal and a second virtual channel signal, a second adder to subtract the second virtual channel signal from the first virtual channel signal, a first filter to perform filtering of a signal outputted from the first adder based on a ratio of a sum of an ipsilateral transfer function and a contralateral transfer function in a virtual location to a sum of an ipsilateral transfer function and a contralateral transfer function in a location of an actual speaker, a second filter to perform filtering of a signal outputted from the second adder based on a ratio of a subtraction between the ipsilateral transfer function and the contralateral transfer function in the virtual location to a subtraction between the ipsilateral transfer function and the contralateral transfer function in the location of the actual speaker, a third adder to add a signal outputted from the first filter and a signal outputted from the second filter, and a fourth adder to subtract the signal outputted from the second filter from the signal outputted from the first filter. In this instance, the first filter performs the filtering of sum of the first virtual channel signal and the second virtual channel signal based on ratio of a sum of the ipsilateral transfer function and the contralateral transfer function in the virtual location to a sum of the ipsilateral transfer function and the contralateral transfer function in the location of the actual speaker. Also, the second filter performs the filtering of subtraction between the first virtual channel signal and the second virtual channel signal based on ratio of a subtraction between the ipsilateral transfer function and the contralateral transfer function in the virtual location to a subtraction between the ipsilateral transfer function and the contralateral transfer function in the location of the actual speaker.

Also, the speaker apparatus further includes a fast Fourier transform (FFT) unit being installed on a front-end of the first adder and the second adder, and performing a FFT of the first virtual channel signal and the second virtual channel signal, an inverse FFT (IFFT) unit being installed on a back-end of the third adder and the fourth adder, and performing an IFFT of a signal outputted from the third adder and a signal outputted from the fourth adder, a plurality of delay units to delay each of signals outputted from a plurality of actual speakers, a fifth adder to add a signal outputted from one of the plurality of delay units and a first signal outputted from the IFFT unit, and a sixth adder to add a signal outputted from one of the plurality of delay units and a second signal outputted from the IFFT unit. In this instance, the plurality of delay units includes a first delay unit to delay a front first direction channel signal, a second delay unit to delay a front second direction channel signal, a third delay unit to delay a front third direction channel signal, a fourth delay unit to delay a low frequency effect channel signal, a fifth delay unit to delay a surround first direction channel signal, and a sixth delay unit to delay a surround second direction channel signal, and the fifth adder adds a signal outputted from the fifth delay unit and the first signal outputted from the IFFT unit, and outputs a result of the addition via the surround first direction speaker, and the sixth adder adds a signal outputted from the sixth delay unit and the second signal outputted from the IFFT unit, and outputs a result of the addition via the surround second direction speaker.

Also, the virtual speaker apparatus further includes a fifth adder to add a surround first direction channel signal to a signal outputted from the third adder, a sixth adder to add a surround second channel signal to a signal outputted from the fourth adder, and an Inverse Modified Discrete Cosine Transform (IMDCT) unit to receive a front first direction channel signal, a front second direction channel signal, a front third direction channel signal, a low frequency effect channel signal, a signal outputted from the fifth adder, and a signal outputted from the sixth adder, and to perform an IMDCT of the received signals.

Also, the virtual speaker apparatus further includes an IMDCT unit to receive a front first direction channel signal, a front second direction channel signal, a front third direction channel signal, a low frequency effect channel signal, a first signal outputted from the third adder, and a second signal outputted from the fourth adder, and to perform an IMDCT of the received signals, a first delay unit to phase-delay the IMDCT-transformed first signal, a second delay unit to phase-delay the IMDCT-transformed second signal, a fifth adder to add an IMDCT-transformed surround first direction channel signal and a signal outputted from the first delay unit, and a sixth adder to add an IMDCT-transformed surround second direction channel signal and a signal outputted from the second delay unit.

According to other example embodiments of the present disclosure, a method of processing a virtual speaker may be provided. The method includes a first adding operation to add a first virtual channel signal and a second virtual channel signal, a second adding operation to subtract the second virtual channel signal from the first virtual channel signal, a first filtering operation to perform filtering of a result signal of the summation in the first adding operation, based on a ratio of a sum of an ipsilateral transfer function and a contralateral transfer function in a virtual location to a sum of an ipsilateral transfer function and a contralateral transfer function in a location of an actual speaker, a second filtering operation to perform filtering of a result signal of the subtraction in the second adding operation, based on a ratio of a subtraction between the ipsilateral transfer function and the contralateral transfer function in the virtual location to a subtraction between the ipsilateral transfer function and the contralateral transfer function in the location of the actual speaker, a third adding operation to add a first signal filtered in the first filtering operation and a second signal filtered in the second filtering operation, and a fourth adding operation to subtract the second signal filtered in the second filtering operation from the first signal filtered in the first filtering operation.

In this instance, the first filter performs the filtering of sum of the first virtual channel signal and the second virtual channel signal based on ratio of a sum of the ipsilateral transfer function and the contralateral transfer function in the virtual location to a sum of the ipsilateral transfer function and the contralateral transfer function in the location of the actual speaker. Also, the second filter performs the filtering of subtraction between the first virtual channel signal and the second virtual channel signal based on ratio of a subtraction between the ipsilateral transfer function and the contralateral transfer function in the virtual location to a subtraction between the ipsilateral transfer function and the contralateral transfer function in the location of the actual speaker.

Also, the virtual speaker processing method further includes an FFT operation being performed in advance of the first adding operation and the second adding operation, and performing an FFT of the first virtual channel signal and the second virtual channel signal, an IFFT operation being performed after the third adding operation and the fourth adding operation, and performing an IFFT of a result signal of the third adding operation and a result signal of the fourth adding operation, a plurality of delaying operations delaying each of signals outputted from a plurality of actual speakers, a fifth adding operation adding a result signal from one of the plurality of delaying operations and a first result signal of the IFFT operation, and a sixth adding operation adding a result signal from one of the plurality of delaying operations and a second result signal of the IFFT operation. In this instance, the plurality of delaying operations respectively delay a front first direction channel signal, a front second direction channel signal, a front third direction channel, a low frequency effect channel signal, a surround first direction channel signal, and a surround second direction channel signal.

Also, the virtual speaker processing method further includes a fifth adding operation to add a surround first direction channel signal and a result signal of the third adding operation, a sixth adding operation to add a surround second channel signal and a result signal of the fourth adding operation, and an IMDCT performing operation to receive a front first direction channel signal, a front second direction channel signal, a front third direction channel signal, a low frequency effect channel signal, a result signal of the fifth adding operation, and a result signal of the sixth adding operation, and to perform an IMDCT of the received signals.

Also, the virtual speaker processing method includes an IMDCT performing operation to receive a front first direction channel signal, a front second direction channel signal, a front third direction channel signal, a low frequency effect channel signal, a first signal outputted from the third adder, and a second signal outputted from the fourth adder, and to perform an IMDCT of the received signals, a first delaying operation to phase-delay the IMDCT-transformed first signal, a second delaying operation to phase-delay the IMDCT-transformed second signal, a fifth adding operation to add an IMDCT-transformed surround first direction channel signal to a result signal of the first delaying operation, and a sixth adding operation to add an IMDCT-transformed surround second direction channel signal to a result signal of the second delaying operation.

Additional aspects and/or advantages will be set forth in part in the description which follows and, in part, will be apparent from the description, or may be learned by practice of embodiments.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a diagram illustrating an example of a configuration of a virtual 7.1 channel speaker system using a 5.1 channel speaker system according to an embodiment;

FIG. 2 is a block diagram illustrating a back-left virtual speaker generating apparatus and a back-right virtual speaker generating apparatus of a 7.1 channel speaker system, when a scheme is asymmetric according to an embodiment;

FIG. 3 is a block diagram illustrating a back-left virtual speaker generating apparatus and a back-right virtual speaker generating apparatus of a 7.1 channel speaker system, when a scheme is symmetric according to an embodiment;

FIG. 4 is a diagram illustrating a configuration of a virtual speaker circuit according to an embodiment;

FIG. 5 is a diagram illustrating an example of a virtual speaker apparatus according to an embodiment;

FIG. 6 is a diagram illustrating an example of an overlap-adding scheme according to an embodiment;

FIG. 7 is a diagram illustrating an example of a virtual speaker apparatus that is a combination of a virtual speaker circuit and an audio decoder according to an embodiment; and

FIG. 8 is a diagram illustrating another example of a virtual speaker apparatus that is a combination of a virtual speaker circuit and an audio decoder according to an embodiment.

### DETAILED DESCRIPTION

Reference will now be made in detail to example embodiments, examples of which are illustrated in the accompanying drawings, wherein like reference numerals refer to the like elements throughout. Example embodiments are described below to explain the present disclosure by referring to the figures.

Generally, a technology that enables a user to experience a virtual audio channel in addition to a physical sound source is described as a virtual speaker. The virtual speaker technology utilizes a technology that compares sounds that come in both ears and determines a direction from which the sound is transferred.

Two factors used for evaluating a spatial location of a sound source in a free field are an Inter-aural Time Difference (ITD) and an Inter-aural Intensity Difference (IID). The ITD is defined as a difference between the arrival time of sound waves arriving at left and right ears, and the IID is defined as a difference between sound pressure levels of sound waves arriving at left and right ears. Generally, a recognized lateral drift is proportional to a phase difference between sounds arriving at both ears. However, when a wave length of about 15 kHz that corresponds to a diameter of a human head, the recognized lateral drift may occupy more than the wave length of the diameter of the human head in a frequency of more than 15 kHz, and thus, aliasing may occur. Accordingly, for frequencies greater than 15 kHz, the phase is of no use in determining the spatial location.

However, for frequencies greater than 15 kHz, the head of the human shields the ear that is most distant from the sound, and thus, the ear receives a weaker sound intensity than the other ear. In this instance, an intensity difference of the sound at both ears is defined as the IID, and an audio signal having a bandwidth greater than 15 kHz is more affected by the IID than by ITD.

The concepts of IID and ITD may explain much and enhance understanding of the mechanism that humans use to recognize a location based on the sound. However, determining location based on only the IID and ITD may cause a cone of confusion that is not able to provide a unique spatial position. The cone of confusion may occur because diffraction or absorption of the perceived sound caused by the human body, such as hair, an external ear, or a shoulder, is not considered. Although it is not easy to mathematically and accurately understand and predict a sound phenomenon occurring in a real life, a direction-dependent frequency response of an ear may be obtained by a simulation, an empirical measurement, or a physical model based on a large amount of research data, as a first step for understanding a spectral cue. The measured data is referred to as Head-related transfer function (HRTF), and the HRTF synthesizes a direction dependent acoustic filter in a free field. The binaural synthesis through the HRTF is performed by convolving an input signal by using a pair of HRTFs.

$$x = hx \\ x = [ \begin{matrix}{x}_{L} \\ {x}_{R}\end{matrix} ] , \\ h = [ \begin{matrix}{H}_{L} \\ {H}_{R}\end{matrix} ] \qquad [ Equation 1 ]$$

Here, x is the input signal, x is a column vector of the binaural signal, and h is a column vector including the pair of HRTFs. The synthesized x is more proper to a play system based on a headphone, and thus, is referred to as a binaural signal. The binaural signal may be represented as a sum of sounds that are mapped with various different locations as given in Equation 2.

$$x = {\sum }_{i = 1}^{N} {h}_{i} {x}_{i} \qquad [ Equation 2 ]$$

Here, hᵢ is an HRTF for xᵢ.

To transfer the binaural signal via a loudspeaker, a process of appropriately filtering based on a transfer function having a 2×2 matrix C is performed.

$$y = Cx \\ y = [ \begin{matrix}{y}_{L} \\ {y}_{R}\end{matrix} ] , \\ C = [ \begin{matrix}{C}_{11} {C}_{12} \\ {C}_{21} {C}_{22}\end{matrix} ] \qquad [ Equation 3 ]$$

The loudspeaker signal y vector is referred to as a loudspeaker binaural signal, and a filter C is referred to as a crosstalk canceller. In a standard-stereo listening environment, an ear signal is associated with a speaker signal based on Equation 4.

$$e = Ay \\ e = [ \begin{matrix}{e}_{L} \\ {e}_{R}\end{matrix} ] , \\ A = [ \begin{matrix}{A}_{LL} {A}_{RL} \\ {A}_{LR} {A}_{RR}\end{matrix} ] \qquad [ Equation 4 ]$$

Here, e is a column vector of the ear signal, A is an acoustical transfer matrix of the ear signal, and y is a column vector of the speaker signal. The ear signal is assumed to be measured by an ideal transducer that is able to catch all directional features of a head response in an ear canal. Also, an A_{xy} function provides a transfer function of a speaker Xε{L, R}, and includes a frequency response of the speaker, an air propagation, and a head response. A may be factorized as given in Equation 5.

$$A = HS \\ H = [ \begin{matrix}{H}_{LL} {H}_{RL} \\ {H}_{LR} {H}_{RR}\end{matrix} ] , \\ S = [ \begin{matrix}{S}_{L} {A}_{L} & 0 \\ 0 & {S}_{R} {A}_{R}\end{matrix} ] \qquad [ Equation 5 ]$$

Here, H is an HRTF matrix that is normalized as a free field response from a center of the head, and S, which is a transfer matrix of the speaker and air, explains a frequency response of the speaker and air propagation that is transferred to a listener via air. Sₓ is a frequency response of a speaker X, and Aₓ represents a transfer function of air propagation from the speaker X to the center of the head.

To accurately transfer the binaural signal to an ear of the human, a crosstalk canceller C is determined to be inverse of the transfer function as given in Equation 6.

C=A⁻¹=S⁻¹H⁻¹ [Equation 6]

Here, H⁻¹ is an inverse of the head transfer matrix, and S⁻¹ is an inverse filter of a response of each speaker and is represented as Equation 7.

$${S}^{- 1} = [ \begin{matrix}1 / {S}_{L} {A}_{L} & 0 \\ 0 & 1 / {S}_{R} {A}_{R}\end{matrix} ] \qquad [ Equation 7 ]$$

Here, 1/S_{X} item is an inverse of a speaker frequency response and 1/A_{X} item is an inverse of air propagation.

When the listener is located at an equal distance from two well adjusted high quality loudspeakers, the Equations may be omitted. However, when the listener moves to a location where distances between the location and the two high quality loudspeakers are different from each other, a volume of a nearby located loudspeaker is decreased, and also a time delay is given to enable signals from the two loudspeaker to simultaneously arrive at the listener and to have an identical sound pressure. The described process may be performed by correcting 1/A_{X} in Equation 7.

Connection of a crosstalk canceller having a sufficient modeling delay to be a causal system is needed, and Equation 8 is formulated when a discrete-time modeling delay m is added.

C(z)=z^{-m}S⁻¹(z)H⁻¹(z) [Equation 8]

A desired amount of modeling delay is related to a special embodiment. Also, hereinafter, for ease of description, a modeling delay and a speaker function S⁻¹ item will be omitted and only a head transfer matrix will be considered. Accordingly, a general expression of Equation 5 will be simply represented as Equation 9.

C=H⁻¹ [Equation 9]

Here, an inverse head transfer matrix is expressed as given in Equation 10.

$${H}^{- 1} = [ \begin{matrix}{H}_{RR} & - {H}_{RL} \\ - {H}_{LR} & {H}_{LL}\end{matrix} ] \frac{1}{D} \\ D = {H}_{LL} {H}_{RR} - {H}_{LR} {H}_{RL} \qquad [ Equation 10 ]$$

Here, D is a determinant of a matrix H, and an inverse determinant 1/D is an important factor to determine a stability of an inverse filter, since the inverse determinant 1/D is commonly applied to all terms. When the determinant is “0” in a predefined frequency, a head transfer matrix is a singular, and an inverse matrix does not exist.

A method of embodying the crosstalk canceller assumes a symmetric listening condition, and has an advantage of being easily embodied although a symmetric solution is a unique case of a general solution. When the listening condition is assumed to be symmetric, a transfer function may be defined as given in Equation 11.

Hᵢ=H_{LL}=H_{RR}

H_{c}=H_{LR}=H_{RL} [Equation 11]

Here, Hᵢ is an ipsilateral transfer function, and H_{c} is a contralateral transfer function. When a symmetric parameter is used in Equation 10, it is represented as Equation 12.

$${H}^{- 1} = [ \begin{matrix}{H}_{i} & - {H}_{c} \\ - {H}_{c} & {H}_{i}\end{matrix} ] \frac{1}{{H}_{i}^{2} - {H}_{c}^{2}} \qquad [ Equation 12 ]$$

A symmetric formula indicates a crosstalk canceller using a shuffler. The shuffler calculates a sum of a binaural input signal and a subtraction of the binaural input signal, and appropriately performs filtering each signal. The filtered signal is returned again to an original state based on the summation and the subtraction. In the shuffler, the summation and the subtraction is represented as a unitary matrix U, and the unitary matrix U is referred to shuffler matrix.

$$U = [ \begin{matrix}1 & 1 \\ 1 & - 1\end{matrix} ] \frac{1}{\sqrt{2}} \qquad [ Equation 13 ]$$

A column of the matrix U is an eigenvector of a symmetric 2×2 matrix, and thus, the shuffler matrix U is digitalized into a symmetric matrix H⁻¹ through a similarity transformation.

$${H}^{- 1} = {U}^{- 1} [ \begin{matrix}\frac{1}{{H}_{i} + {H}_{c}} & 0 \\ 0 & \frac{1}{{H}_{i} - {H}_{c}}\end{matrix} ] U \qquad [ Equation 14 ]$$

Accordingly, the crosstalk canceller calculates a shuffler filter Σ that is an inverse of a sum of an ipsilateral response and a contralateral response, and a shuffler filter Δ that is an inverse of a subtraction between the ipsilateral response and the contralateral response, the shuffler filters Σ and Δ being embodied as given in Equation 15.

Σ=1/(Hᵢ+H_{c})

Δ=1/(Hᵢ−H_{c}) [Equation 15]

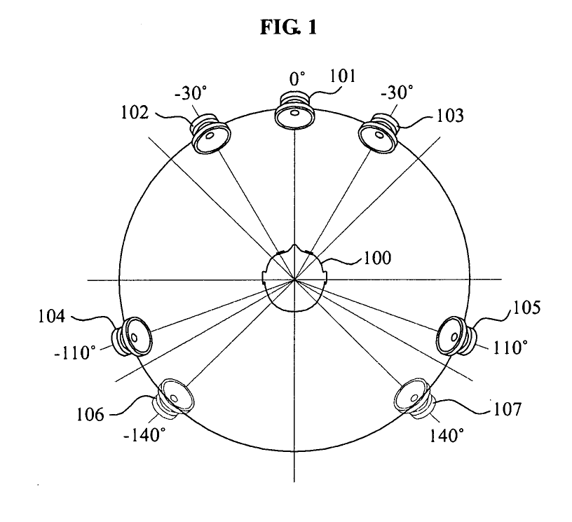

FIG. 1 is a diagram illustrating an example of a configuration of a virtual 7.1 channel speaker system using a 5.1 channel speaker system according to an embodiment.

Referring to FIG. 1, the virtual stereo system needs to consider a speaker which is capable of providing a highest quality, since the virtual stereo system uses a 5.1 channel loudspeakers 101 through 105, and generates two virtual speakers 106 and 107 to embody a 7.1 channel. A first speaker 101 is installed on a location at a zero degrees, namely, a center of a front of a listener 100, and a second speaker 102 is installed on a location at −30 degrees, namely, a front-left of the listener 100, and a third speaker 103 is installed on a location at 30 degrees, namely, a front-right of the listener 100. A fourth speaker 104 is a surround left speaker installed in a location at −110 degrees based on the front of the listener 100, and a fifth speaker 105 is a surround right speaker installed in a location at 110 degrees based on the front of the listener 100. A first virtual speaker 106 is a virtual speaker that enables the listener 100 to experience as though a speaker is installed in a location at −140 degrees, namely a back-left based on the front of the listener 100, and the first virtual speaker 106 enables a first virtual channel signal to be played via the fifth speaker 105. The second virtual speaker 107 is a virtual speaker that is recognized as though being installed in a location at 140 degrees, namely a back-right of the listener 100, and enables a second virtual channel signal to be played via the fourth speaker 104 and the fifth speaker 105.

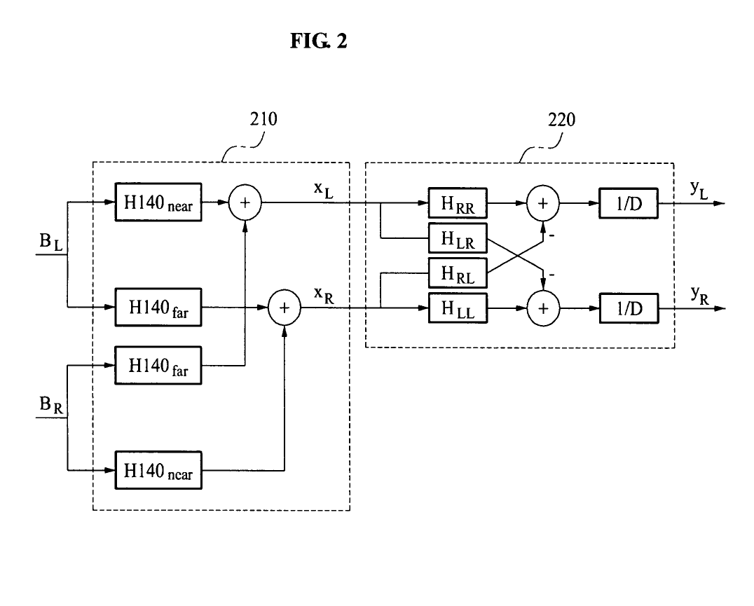

FIG. 2 is a block diagram illustrating a back-left virtual speaker generating apparatus and a back-right virtual speaker generating apparatus of a 7.1 channel speaker system, when a scheme is asymmetric according to an embodiment.

Referring to FIG. 2, an HRTF localization unit 210 outputs signals x_{L} and x_{R} that have a back-directional feature by using an HRTF filtering that matches sound with a back-left direction (B_{L}) and with a back-right direction (B_{R}).

$${x}_{B} = {h}_{B} B \\ {x}_{B} = [ \begin{matrix}{x}_{L} \\ {x}_{R}\end{matrix} ] , \\ h = [ \begin{matrix}H {140}_{near} & H {140}_{far} \\ H {140}_{far} & H {140}_{near}\end{matrix} ] , \\ B = [ \begin{matrix}{B}_{L} \\ {B}_{R}\end{matrix} ] \qquad [ Equation 16 ]$$

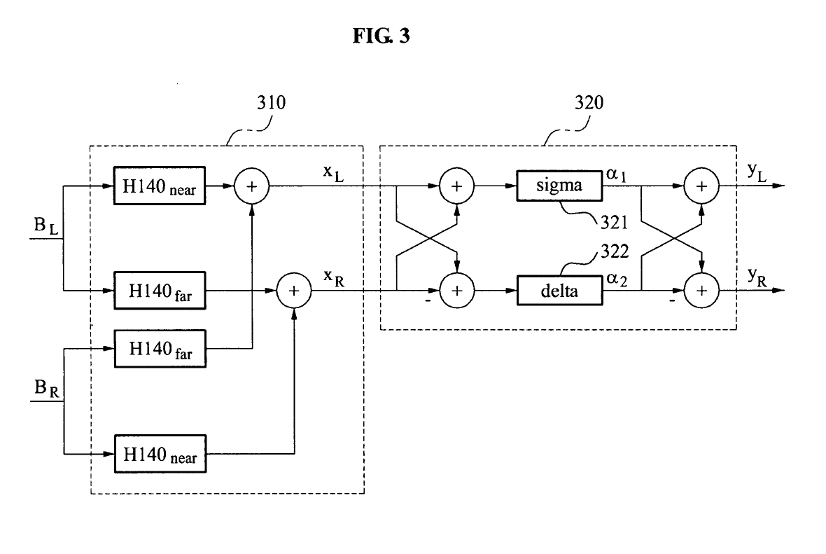

Here, x_{L} and x_{R} are inputted into a crosstalk canceller 220, and are outputted as speaker outputs y_{L} and y_{R} which are constituted as signals from which crosstalk is eliminated by the crosstalk canceller. When the virtual back listening environment is in a symmetric condition based on two surround speakers, a shuffler crosstalk circuit may be used. An HRTF location measurement and crosstalk canceller circuit constructed by using the shuffler may be represented as illustrated in FIG. 3.

FIG. 3 is a block diagram illustrating a back-left virtual speaker and a back-right virtual speaker of a 7.1 channel speaker system, when a scheme is symmetric according to an embodiment.

Referring to FIG. 3, an HRTF localization unit 310 outputs signals x_{L} and x_{R} having a back-directional feature by using HRTF filtering that matches sound with a back-left direction (B_{L}) and with a back-right direction (B_{R}).

A Sigma 321 and a Delta 322 of a crosstalk canceller 320 are defined as Equation 17.

$$Sigma = \frac{1}{2 ( {H}_{i} + {H}_{c} )} \\ Delta = \frac{1}{2 ( {H}_{i} - {H}_{c} )} \qquad [ Equation 17 ]$$

The crosstalk canceller 320, in a case of symmetric state, may reduce, by two, a number of filterings performed compared with a number of filterings performed in the crosstalk canceller 220 in a case of an asymmetric state. Here, to further simplify the operation of eliminating crosstalk of a virtual back channel, an expression may be formulated to have a minimal filtering by combining an HRTF localization process and a crosstalk cancellation process, and a final output y may be expressed as given in Equation 18.

$$y = [ \begin{matrix}1 & 1 \\ 1 & - 1\end{matrix} ] [ \begin{matrix}Sigma & 0 \\ 0 & Delta\end{matrix} ] [ \begin{matrix}1 & 1 \\ 1 & - 1\end{matrix} ] {x}_{B} \qquad [ Equation 18 ]$$

Here, when Equation 16 is substituted in Equation 18, it is represented as given in Equation 19.

$$y = \begin{matrix}[ \begin{matrix}1 & 1 \\ 1 & - 1\end{matrix} ] [ \begin{matrix}Sigma & 0 \\ 0 & Delta\end{matrix} ] \\ [ \begin{matrix}1 & 1 \\ 1 & - 1\end{matrix} ] [ \begin{matrix}H {140}_{near} & H {140}_{far} \\ H {140}_{far} & H {140}_{near}\end{matrix} ] B\end{matrix} \qquad [ Equation 19 ]$$

When a third item and a fourth item of a right term in Equation 19 are combined and expanded, it is represented as given in Equation 20.

$$y = \begin{matrix}[ \begin{matrix}1 & 1 \\ 1 & - 1\end{matrix} ] [ \begin{matrix}Sigma & 0 \\ 0 & Delta\end{matrix} ] \\ [ \begin{matrix}H {140}_{near} + H {140}_{far} & H {140}_{far} + H {140}_{near} \\ H {140}_{near} - H {140}_{far} & H {140}_{far} - H {140}_{near}\end{matrix} ] B\end{matrix} \qquad [ Equation 20 ]$$

When a second item and a third item of a right term in Equation 20 are combined and expanded, it is represented as given in Equation 21.

$$y = \begin{matrix}[ \begin{matrix}1 & 1 \\ 1 & - 1\end{matrix} ] \\ [ \begin{matrix}( H {140}_{near} + H {140}_{far} ) Sigma & ( H {140}_{far} + H {140}_{near} ) Sigma \\ ( H {140}_{near} - H {140}_{far} ) Delta & ( H {140}_{far} - H {140}_{near} ) Delta\end{matrix} ] B\end{matrix} \qquad [ Equation 21 ]$$

When Equation 21 is decomposed, it is represented as given in Equation 22.

$$y = [ \begin{matrix}1 & 1 \\ 1 & - 1\end{matrix} ] [ \begin{matrix}Σ & 0 \\ 0 & Δ\end{matrix} ] [ \begin{matrix}1 & 1 \\ 1 & - 1\end{matrix} ] {x}_{B} \\ Σ = ( H {140}_{near} + H {140}_{far} ) Sigma \\ Δ = ( H {140}_{near} - H {140}_{far} ) Delta \qquad [ Equation 22 ]$$

Here, H140ₙₑₐᵣ is a head transfer function transferred to an ear relatively close to a sound source in a direction of 140 degrees, and H140_{far} is a head transfer function transferred to an ear relatively far from the sound source in a direction of 140 degrees. Sigma and Delta are values illustrated in Equation 17.

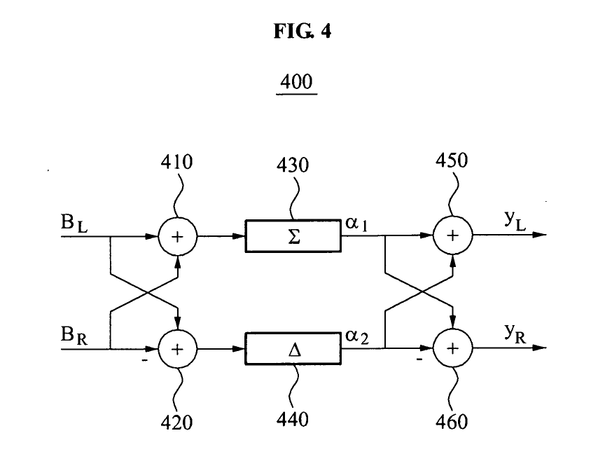

Equation 22 may be represented as a virtual speaker circuit 400 as illustrated in FIG. 4.

FIG. 4 is a diagram illustrating a configuration of a virtual speaker circuit according to an embodiment.

Referring to FIG. 4, the virtual speaker circuit 400 includes four adders 410, 420, 450, and 460, and two filters 430 and 440.

The first adder 410 adds a first virtual channel signal and a back second virtual channel signal. As an example, the first adder 410 may calculate a sum (B_{L}+B_{R}) of a signal (B_{L}) that is intended to be experienced at a location of −140 degrees, namely a location of the first speaker 106, and a signal (B_{R}) that is intended to be experienced at a location of 140 degrees, namely, a location of the second virtual speaker 107. The first virtual channel signal is a signal to be outputted from the first virtual speaker and the second virtual channel signal is a signal to be outputted from the second virtual speaker.

The second adder 420 subtracts the second virtual channel signal from the first virtual channel signal. As an example, the second adder 420 may calculate subtraction (B_{L}−B_{R}) between the signal (B_{L}) that is intended to be experienced at a location of −140 degrees, namely a location of the first speaker 106, and the signal (B_{R}) that is intended to be experienced at a location of 140 degrees, namely, a location of the second virtual speaker 107.

The first filter 430 performs filtering of a signal outputted from the first adder 410 based on a ratio of a sum of an ipsilateral transfer function and a contralateral transfer function in a virtual location to a sum of an ipsilateral transfer function and a contralateral transfer function in a location of an actual speaker. As an example, the first filter 430 may perform the filtering of a sum of the first virtual channel signal and the second virtual channel signal based on ratio of a sum of the ipsilateral transfer function and the contralateral transfer function in the virtual location to a sum of the ipsilateral transfer function and the contralateral transfer function in the location of the actual speaker.

The second filter 440 performs filtering of a signal outputted from the second adder based on a ratio of a subtraction between the ipsilateral transfer function and the contralateral transfer function in the virtual location to a subtraction between the ipsilateral transfer function and the contralateral transfer function in the location of the actual speaker. As an example, the second filter 440 may perform the filtering of subtraction between the first virtual channel signal and the second virtual channel signal based on a ratio of a subtraction between the ipsilateral transfer function and the contralateral transfer function in the virtual location to a subtraction between the ipsilateral transfer function and the contralateral transfer function in the location of the actual speaker.

The third adder 450 adds a signal outputted from the first filter 430 and a signal outputted from the second filter 440. As an example, the third adder 450 may add a signal outputted from the first filter 430 and a signal outputted from the second filter 440, and outputs a summation result signal yL via the fifth speaker 105 that is a surround left speaker.

The fourth adder 460 subtracts the signal outputted from the second filter 440 from the signal outputted from the first filter 430.

As described above, the virtual speaker circuit 400 according to example embodiments may decrease a complexity and may greatly decrease a coefficient value of a filter to be stored, since a total amount of filtering to be performed is relatively small, when compared, for example, with a configuration where the asymmetric or symmetric HRTF localization unit 210 or 310 and the crosstalk canceller 220 or 320 are connected based on a cascade.

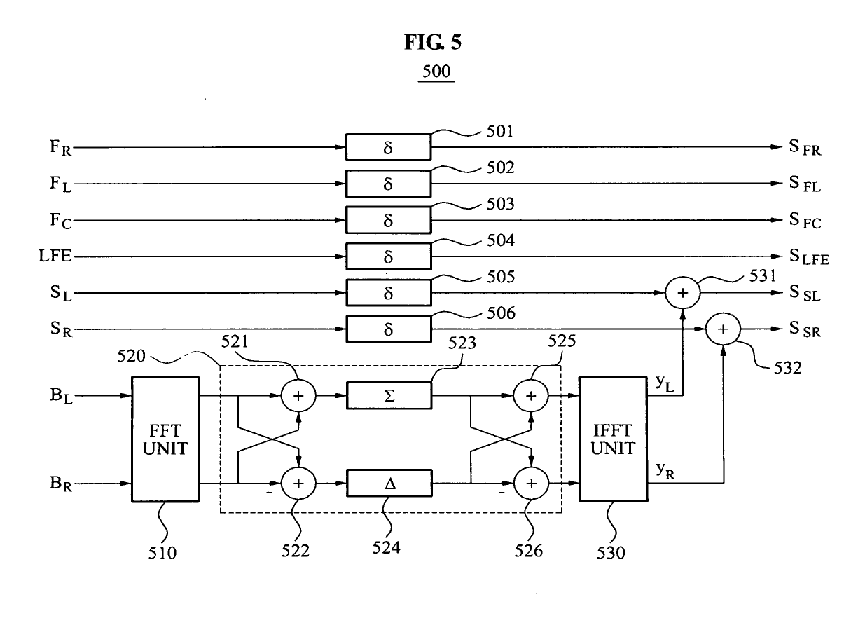

FIG. 5 is a diagram illustrating an example of a virtual speaker apparatus according to an embodiment.

Referring to FIG. 5, in the virtual speaker apparatus 500, channels played through an actual speaker include a front left (FL) channel, a front right (FR) channel, a front center (FC) channel, a low frequency effect (LFE) channel, a surround left (SL) channel, and a surround right (SR) channel. Channels which use the surround left speaker (S_{SL}) and the surround right speaker (S_{SR}) and enable a user to experience a virtual speaker through a virtual speaker process, are a back left channel (BL) and a back right (BR) channel.

The virtual speaker 500 may include, for example, a first delay unit 501, a second delay unit 502, a third delay unit 503, a fourth delay unit 504, a fifth delay unit 505, a sixth delay unit 506, an FFT unit 510, a virtual speaker circuit 520, an IFFT unit 530, a fifth adder 531, and a sixth adder 532.

The first delay unit 501 delays a front right channel signal (F_{R}). That is, the first delay unit 501 delays the front right channel signal (F_{R}) as long as signals are under virtual speaker process, so that a time when the virtual speaker processed signals are outputted via the surround left speaker (S_{SL}) and the surround right speaker (S_{SR}) is identical to a time when the front right channel signal (F_{R}) is outputted via the front right speaker (S_{FR}).

The second delay unit 502 delays a front left channel signal (F_{L}). That is, the second delay unit 502 delays the front left channel signal (F_{L}) as long as signals are under virtual speaker process, so that a time when the virtual speaker processed signals are outputted via the surround left speaker (S_{SL}) and the surround right speaker (S_{SR}) is identical to a time when the front left channel signal (F_{L}) is outputted via the front left speaker (S_{FL}).

The third delay unit 503 delays a front center channel signal (F_{C}). That is, the third delay unit 503 delays the front center channel signal (F_{C}) while signals are under a virtual speaker process, so that a time when the virtual speaker processed signals are outputted via the surround left speaker (S_{SL}) and the surround right speaker (S_{SR}) is identical to a time when the front center channel signal (F_{C}) is outputted via the front center speaker (S_{FC}).

The fourth delay unit 504 delays a low frequency effect channel signal (LFE). That is, the fourth delay unit 504 delays the low frequency effect channel signal (LFE) as long as signals are under virtual speaker process, so that a time when the virtual speaker processed signals are outputted via the surround left speaker (S_{SL}) and the surround right speaker (S_{SR}) is identical to a time when the low frequency effect channel signal (LFE) is outputted via a low frequency speaker (S_{LEF}).

The fifth delay unit 505 delays a surround left channel signal (S_{L}). That is, the fifth delay unit 505 delays the surround left channel signal (S_{L}) as long as signals are under a virtual speaker process, so that a time when the virtual speaker processed signals are outputted via the surround left speaker (S_{SL}) and the surround right speaker (S_{SR}) is identical to a time when the surround left channel signal (S_{L}) is outputted via the surround left speaker (S_{SL}).

The sixth delay unit 506 delays a surround right channel signal (S_{R}). That is, the sixth delay unit 506 delays the surround right channel signal (S_{R}) as long as signals are under a virtual speaker process, so that a time when the virtual speaker processed signals are outputted via the surround left speaker (S_{SL}) and the surround right speaker (S_{SR}) is identical to a time when the surround right channel signal (S_{R}) is outputted via the surround right speaker (S_{SR}).

A temporal domain is transformed into a frequency domain to be used for filtering in the virtual speaker process. Generally, a filtering performed in the frequency domain is performed quicker than a convolution performed in the temporal domain, and thus, a fast Fourier transform (FFT) unit 510 and an inverse fast Fourier transform (IFFT) unit 530 are used at a front end and a back end of the virtual speaker circuit 520 to transform from the temporal domain to the frequency domain and vice-versa.

The FFT unit 510 performs a FFT of a back left channel signal (B_{L}) and a back right channel signal (B_{R}).

The virtual speaker circuit 520 may include, for example, a first adder 521, a second adder 522, a first filter 523, a second filter 524, a third adder 525, and a fourth adder 526, and may process signals that are felt as though being outputted via a virtual speaker, by using the FFT-transformed back left channel signal (B_{L}) and FFT-transformed back right channel signal (B_{R}).

The first adder 521 adds the FFT-transformed back right channel signal and the FFT-transformed back left channel signal outputted from the FFT unit 510.

The second adder 522 subtracts the FFT-transformed back right channel signal from the FFT-transformed back left channel signal outputted from the FFT unit 510.

The first filter 523 perform filtering of a signal outputted from the first adder 521 based on a ratio of a sum of an ipsilateral transfer function and a contralateral transfer function in a virtual location to a sum of an ipsilateral transfer function and a contralateral transfer function in a location of an actual speaker.

The second filter 524 perform filtering of a signal outputted from the second adder 522 based on a ratio of a subtraction between the ipsilateral transfer function and the contralateral transfer function in the virtual location to a subtraction between the ipsilateral transfer function and the contralateral transfer function in the location of the actual speaker.

The third adder 525 adds a signal outputted from the first filter 523 and a signal outputted from the second filter 524.

The fourth adder 526 subtracts the signal outputted from the second filter 524 from the signal outputted from the first filter 523.

The IFFT unit 530 performs an IFFT of a signal outputted from the third adder 525 and a signal outputted from the fourth adder 526.

The fifth adder 531 adds a signal outputted from the fifth delay unit 505 and a first signal (y_{L}) outputted from the IFFT unit 530.

The sixth adder 532 adds a signal outputted from the sixth delay unit 506 and a second signal (y_{R}) outputted from the IFFT unit 530.

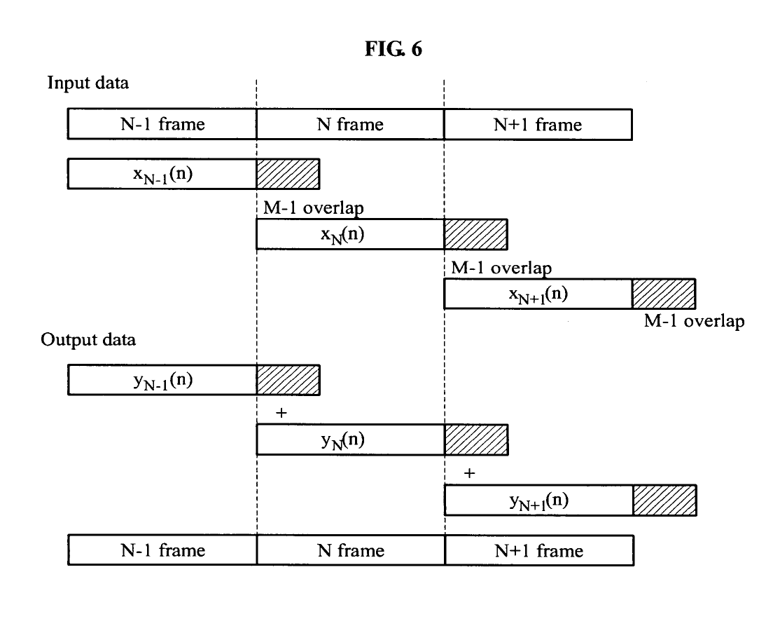

The virtual speaker circuit 520 is performed in a frame unit, and an overlap-add method as illustrated in FIG. 6 is widely used to reflect a response of a previous frame to a current frame.

FIG. 6 is a diagram illustrating an example of an overlap-adding scheme according to an embodiment.

Referring to FIG. 6, to maximally reflect the response, overlapping is performed, and a frame boundary is smoothed by windowing on an input and an output by using a sine window.

As an example, in a configuration using the overlap-adding method, when 50% data is overlapped, an actual data may have a delay as long as one frame. Accordingly, the first through sixth delay unit 501 through 506 may delay as long as a number of samples in one frame of the signals (B_{L} and B_{R}) that are transformed into the frequency domain, compared with signals (F_{L}, F_{R}, F_{C}, LFE, S_{L}, S_{R}) that are not transformed into a frequency domain.

Also, when an audio decoder that is an audio source is of a type performing a decoding in a transform domain, there is no need for performing a transformation of a virtual speaker process. Generally, an audio codec performs an encoding process and a decoding process in the frequency domain. Particularly, a modified discrete cosine transform (MDCT) is excellent in coding efficiency, compared with an FFT or a DCT, and for this reason, various audio codecs, such as AAC, MP3, Dolby Digital, Dolby Digital Plus, AAC+, and the like, perform an encoding process and a decoding process in the MDCT domain.

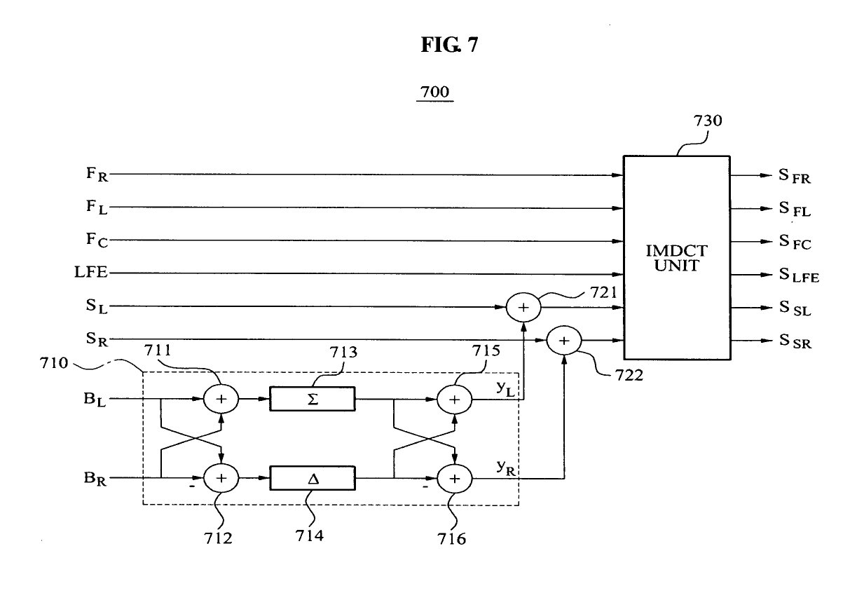

FIG. 7 is a diagram illustrating an example of a virtual speaker apparatus that is a combination of a virtual speaker circuit and an audio decoder according to an embodiment.

Referring to FIG. 7, an audio codec (not illustrated) includes a virtual speaker circuit 710 to perform a virtual speaker process just before an operation of transforming a frequency domain into a temporal domain, and thus may omit a frequency domain transforming operation that is additionally performed at a front end of the virtual speaker process circuit and an a temporal domain transforming operation that is additionally performed at a back end of the virtual speaker process, unlike the 7.1 channel speaker system 500 of FIG. 5

The virtual speaker apparatus 700 includes, for example, a virtual speaker circuit 710, a fifth adder 721, a sixth adder 722, and an IMDCT unit 730.

The virtual speaker circuit 710 includes, for example, a first adder 711, a second adder 712, a first filter 713, a second filter 714, a third adder 715, and a fourth adder 716.

The first adder 711 adds a first virtual channel signal and a second virtual channel signal. As an example, the first adder 711 adds a back left channel signal and a back right channel signal. The back left channel signal may be a signal that is perceived as being outputted from a virtual speaker located at a back left of a listener, and the back right channel signal may be a signal that is perceived as being outputted from a virtual speaker located at a back right of the listener.

The second adder 712 subtracts the second virtual channel signal from the first virtual channel signal. As an example, the second adder 712 may subtract the back right channel signal from the back left channel signal.

The first filter 713 performs filtering of a signal outputted from the first adder 711 based on a ratio of a sum of an ipsilateral transfer function and a contralateral transfer function in a virtual location to a sum of an ipsilateral transfer function and a contralateral transfer function in an actual speaker location.

The second filter 714 performs filtering of a signal outputted from the second adder 712 based on a ratio of a subtraction between the ipsilateral transfer function and the contralateral transfer function in the virtual location to a subtraction of the ipsilateral transfer function and the contralateral transfer function in the actual speaker location.

The third adder 715 adds a signal outputted from the first filter 713 and a signal outputted from the second filter 714.

The fourth adder 716 subtracts the signal outputted from the second filter 714 from the signal outputted from the first filter 713.

The fifth adder 721 adds a signal outputted from a surround first direction channel signal and a signal outputted from the third adder 715.

The sixth adder 722 adds a signal outputted from a surround second direction channel signal and a signal outputted from the fourth adder 716.

The IMDCT unit 730 receives a front right channel signal (F_{R}), a front left channel signal (F_{L}), a front center channel signal (F_{C}), a low effect channel signal (LFE), a signal outputted from a fifth adder 721, and a signal outputted from a sixth adder 722, and performs an inverse modified discrete cosine transform (IMDCT) of the received signals.

The front left channel signal (F_{R}), a left right channel signal (F_{L}), a front center channel signal (F_{C}), and a low frequency effect channel signal (LFE) are respectively decoded by an audio decoder (not illustrated) are transformed into a temporal domain by the IMDCT unit 730.

The back left channel signal (B_{L}) and the back right channel signal (B_{R}) are virtual-speakers processed by the virtual speaker circuit 710. The virtual speaker processed left signal (y_{L}) is added to a surround left channel signal (S_{L}) by the fifth adder 721, is transformed into the temporal domain by the IMDCT unit 730, and is outputted via a surround left speaker (S_{SL}). The virtual speaker processed right signal (y_{R}) is added to a surround right channel signal (S_{R}) by the sixth adder 722, is transformed into the temporal domain by the IMDCT unit 730, and is outputted via a surround right speaker (S_{SR}). The virtual speaker circuit 710 has an advantage of being applied to a configuration where a phase is difficult to be applied, such as an MDCT domain, since a filtering is simplified compared with configurations in FIG. 2 and FIG. 3.

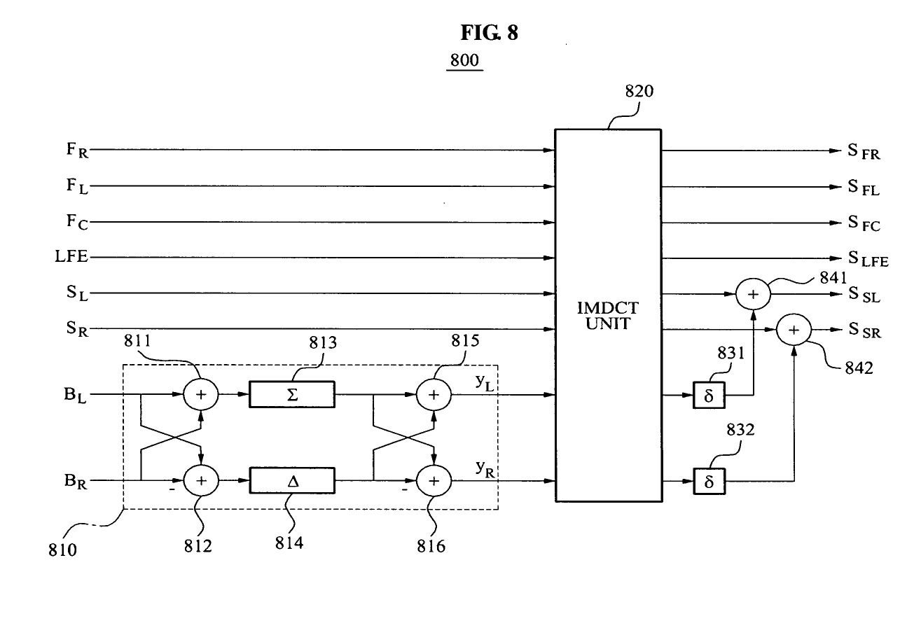

When the first filter 713 and the second filter 714 are designed based on a minimum phase, a phase component is reflected after the IMDCT is performed. When the first filter 713 and the second filter 714 have linear phases and are designed based on the minimum phase, the first filter 713 and the second filter 714 may be embodied as illustrated in FIG. 8. The linear phase may be simply embodied as a sample delay in a temporal domain.

FIG. 8 is a diagram illustrating another example of a virtual speaker apparatus that is a combination of a virtual speaker circuit and an audio decoder according to an embodiment.

Referring to FIG. 8, the virtual speaker circuit 810 includes a first adder 811, a second adder 812, a first filter 813, a second filter 814, a third adder 815, and a fourth adder 816.

The first adder 811 adds a first virtual channel signal and a second virtual channel signal. As an example, the first adder 811 adds a back left channel signal (B_{L}) and a back right channel signal (B_{R}). The back left channel signal (B_{L}) may be a signal that is intended to be felt as though being outputted from a virtual speaker located in a back left, and the back right channel signal (B_{R}) may be a signal that is intended to be felt as though being outputted from a virtual speaker located in a back right.

The second adder 812 subtracts the second virtual channel signal from the first virtual channel signal. As an example, the second adder 712 may subtract the back right channel signal (B_{R}) from the back left channel signal (B_{L}).

The first filter 813 performs filtering of a signal outputted from the first adder 811 based on a ratio of a sum of an ipsilateral transfer function and a contralateral transfer function in a virtual location to a sum of an ipsilateral transfer function and a contralateral transfer function in an actual speaker location.

The second filter 814 performs filtering of a signal outputted from the second adder 812 based on a ratio of a subtraction between the ipsilateral transfer function and the contralateral transfer function in the virtual location to a subtraction of the ipsilateral transfer function and the contralateral transfer function in the actual speaker location.

The third adder 815 adds a signal outputted from the first filter 813 and a signal outputted from the second filter 814.

The fourth adder 816 subtracts the signal outputted from the second filter 814 from the signal outputted from the first filter 813.

The IMDCT unit 820 receives a front right channel signal (F_{R}), a front left channel signal (F_{L}), a front center channel signal (F_{C}), a low effect channel signal (LFE), a surround left channel signal (S_{L}), a surround right channel signal (S_{R}), a first signal outputted from a third adder 815, and a second signal outputted from a fourth adder 816, and performs IMDCT of the received signals.

The first delay unit 831 delays the first signal that is IMDCT-transformed by the IMDCT unit 820. That is, the first delay unit 831 delays the first signal IMDCT-transformed by the IMDCT unit 820 by as much as δ, and thereby reflects a phase factor.

The second delay unit 832 delays the second signal that is IMDCT-transformed by the IMDCT unit 820. That is, the second delay unit 832 delays the second signal IMDCT-transformed by the IMDCT unit 820 by as much as δ, and thereby reflects a phase factor.

The fifth adder 841 adds a signal outputted from the first delay unit 831 and a surround left channel signal that is IMDCT-transformed by the IMDCT unit 820, and outputs the added signal via a surround left speaker.

The sixth adder 842 adds a signal outputted from the second delay unit 832 and a surround right channel signal that is IMDCT-transformed by the IMDCT unit 820, and outputs the added signal via a surround right speaker.

Also, the virtual speaker processing method according to an embodiment may be understood based on the description related to operations of the virtual speaker circuit and the virtual speaker apparatus illustrated in FIGS. 4 through 6.

As described above, example embodiments of the present disclosure may decrease a complexity of a virtual speaker circuit based on a relatively small amount of filtering performed in total, and may provide a virtual speaker apparatus and a virtual speaker processing method that may greatly decrease a coefficient value of a filter to be stored.

The virtual speaker processing method according to exemplary embodiments of the present invention include computer-readable media including program instructions to implement various operations embodied by a computer. The media may also include, alone or in combination with the program instructions, data files, data structures, tables, and the like. The media and program instructions may be those specially designed and constructed for the purposes of the present invention, or they may be of the kind well known and available to those having skill in the computer software arts. Examples of computer-readable media include magnetic media such as hard disks, floppy disks, and magnetic tape; optical media such as CD ROM disks; magneto-optical media such as optical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa. The instructions may be executed on any processor, general purpose computer, or special purpose computer such as a virtual speaker apparatus. Further, the software modules may be controlled by any processor.

Although a few example embodiments have been shown and described, it would be appreciated by those skilled in the art that changes may be made in these example embodiments without departing from the principles and spirit of the disclosure, the scope of which is defined in the claims and their equivalents.

What is claimed is:

1. A virtual speaker apparatus, comprising:
a first adder to add a first virtual channel signal and a second virtual channel signal;
a second adder to subtract the second virtual channel signal from the first virtual channel signal;
a first filter, controlled by a processor, to perform filtering of a signal outputted from the first adder based on a ratio of a sum of an ipsilateral transfer function and a contralateral transfer function in a virtual location to a sum of an ipsilateral transfer function and a contralateral transfer function in a location of an actual speaker;
a second filter to perform filtering of a signal outputted from the second adder based on a ratio of a subtraction between the ipsilateral transfer function and the contralateral transfer function in the virtual location to a subtraction between the ipsilateral transfer function and the contralateral transfer function in the location of the actual speaker;
a third adder to add a signal outputted from the first filter and a signal outputted from the second filter; and
a fourth adder to subtract the signal outputted from the second filter from the signal outputted from the first filter.

2. The apparatus of claim 1, wherein the first filter performs the filtering of a sum of the first virtual channel signal and the second virtual channel signal based on the ratio of the sum of the ipsilateral transfer function and the contralateral transfer function in the virtual location to the sum of the ipsilateral transfer function and the contralateral transfer function in the location of the actual speaker.

3. The apparatus of claim 1, wherein the second filter performs the filtering of a difference between the first virtual channel signal and the second virtual channel signal based on the ratio of the subtraction between the ipsilateral transfer function and the contralateral transfer function in the virtual location to the subtraction between the ipsilateral transfer function and the contralateral transfer function in the location of the actual speaker.

4. The apparatus of claim 1, further comprising:
a fast Fourier transform (FFT) unit, installed on a front-end of the first adder and the second adder, to perform a FFT of the first virtual channel signal and the second virtual channel signal;
an inverse FFT (IFFT) unit, installed on a back-end of the third adder and the fourth adder, to perform an IFFT of a signal outputted from the third adder and a signal outputted from the fourth adder;
a plurality of delay units to delay each signal outputted from a plurality of actual speakers;
a fifth adder to add a signal outputted from one of the plurality of delay units and a first signal outputted from the IFFT unit; and
a sixth adder to add a signal outputted from one of the plurality of delay units and a second signal outputted from the IFFT unit.

5. The apparatus of claim 4, wherein, the plurality of delay units comprises:
a first delay unit to delay a front first direction channel signal;
a second delay unit to delay a front second direction channel signal;
a third delay unit to delay a front third direction channel signal;
a fourth delay unit to delay a low frequency effect channel signal;
a fifth delay unit to delay a surround first direction channel signal; and
a sixth delay unit to delay a surround second direction channel signal;
the fifth adder adding a signal outputted from the fifth delay unit and the first signal outputted from the IFFT unit, and outputting a result of the addition via a surround first direction speaker, and
the sixth adder adding a signal outputted from the sixth delay unit and the second signal outputted from the IFFT unit, and outputting a result of the addition via a surround second direction speaker.

6. The apparatus of claim 1, further comprising:
a fifth adder to add a surround first direction channel signal to a signal outputted from the third adder;
a sixth adder to add a surround second channel signal to a signal outputted from the fourth adder; and
an Inverse Modified Discrete Cosine Transform (IMDCT) unit to receive a front first direction channel signal, a front second direction channel signal, a front third direction channel signal, a low frequency effect channel signal, a signal outputted from the fifth adder, and a signal outputted from the sixth adder, and to perform an IMDCT of the received signals.

7. The apparatus of claim 1, further comprising:
an IMDCT unit to receive a front first direction channel signal, a front second direction channel signal, a front third direction channel signal, a low frequency effect channel signal, a first signal outputted from the third adder, and a second signal outputted from the fourth adder, and to perform an IMDCT of the received signals;
a first delay unit to phase-delay the IMDCT-transformed first signal;
a second delay unit to phase-delay the IMDCT-transformed second signal;
a fifth adder to add an IMDCT-transformed surround first direction channel signal and a signal outputted from the first delay unit; and
a sixth adder to add an IMDCT-transformed surround second direction channel signal and a signal outputted from the second delay unit.

8. A method of processing for a virtual speaker, the method comprising:
a first adding operation using a processor to add a first virtual channel signal and a second virtual channel signal;
a second adding operation subtracting the second virtual channel signal from the first virtual channel signal;
a first filtering operation filtering a result signal of the summation in the first adding operation, based on a ratio of a sum of an ipsilateral transfer function and a contralateral transfer function in a virtual location to a sum of an ipsilateral transfer function and a contralateral transfer function in a location of an actual speaker;
a second filtering operation filtering a result signal of the subtraction in the second adding operation, based on a ratio of a subtraction between the ipsilateral transfer function and the contralateral transfer function in the virtual location to a subtraction between the ipsilateral transfer function and the contralateral transfer function in the location of the actual speaker;
a third adding operation adding a first signal filtered in the first filtering operation and a second signal filtered in the second filtering operation; and
a fourth adding operation subtracting the second signal filtered in the second filtering operation from the first signal filtered in the first filtering operation.

9. The method of claim 8, wherein the first filtering operation performs filtering of a sum of the first virtual channel signal and the second virtual channel signal based on the ratio of the sum of the ipsilateral transfer function and the contralateral transfer function in the virtual location to the sum of the ipsilateral transfer function and the contralateral transfer function in the location of the actual speaker.

10. The method of claim 8, wherein the second filtering operation performs filtering of a difference between the first virtual channel signal and the second virtual channel signal based on the ratio of the subtraction between the ipsilateral transfer function and the contralateral transfer function in the virtual location to the subtraction between the ipsilateral transfer function and the contralateral transfer function in the location of the actual speaker.

11. The method of claim 8, further comprising:
an FFT operation being performed in advance of the first adding operation and the second adding operation, and performing an FFT of the first virtual channel signal and the second virtual channel signal;
an IFFT operation being performed after the third adding operation and the fourth adding operation, and performing an IFFT of a result signal of the third adding operation and a result signal of the fourth adding operation;
a plurality of delaying operations delaying each of signal outputted from a plurality of actual speakers;
a fifth adding operation adding a result signal from one of the plurality of delaying operations and a first result signal of the IFFT operation; and
a sixth adding operation adding a result signal from one of the plurality of delaying operations and a second result signal of the IFFT operation.

12. The method of claim 11, wherein the plurality of delaying operations respectively delay a front first direction channel signal, a front second direction channel signal, a front third direction channel, a low frequency effect channel signal, a surround first direction channel signal, and a surround second direction channel signal.

13. The method of claim 8, further comprising:
a fifth adding operation to add a surround first direction channel signal and a result signal of the third adding operation;
a sixth adding operation to add a surround second channel signal and a result signal of the fourth adding operation; and
an IMDCT performing operation to receive a front first direction channel signal, a front second direction channel signal, a front third direction channel signal, a low frequency effect channel signal, a result signal of the fifth adding operation, and a result signal of the sixth adding operation, and to perform an IMDCT of the received signals.

14. The method of claim 8, further comprising:
an IMDCT performing operation to receive a front first direction channel signal, a front second direction channel signal, a front third direction channel signal, a low frequency effect channel signal, a first signal outputted from the third adder, and a second signal outputted from the fourth adder, and to perform an IMDCT of the received signals;
a first delaying operation to phase-delay the IMDCT-transformed first signal;
a second delaying operation to phase-delay the IMDCT-transformed second signal;
a fifth adding operation to add an IMDCT-transformed surround first direction channel signal to a result signal of the first delaying operation; and
a sixth adding operation to add an IMDCT-transformed surround second direction channel signal to a result signal of the second delaying operation.

15. A computer readable recording media storing a program implementing the method of claim 8.

16. A combination virtual speaker and audio decoding apparatus, comprising:
a first adder to add first and second virtual channel signals;
a second adder to subtract the second virtual channel signal from the first virtual channel signal;
a first filter, controlled by a processor, to perform filtering of a signal outputted from the first adder based on a ratio of a sum of an ipsilateral transfer function and a contralateral transfer function in a virtual location to a sum of an ipsilateral transfer function and a contralateral transfer function in an actual speaker location;
a second filter to perform filtering of a signal outputted from the second adder based on a ratio of a subtraction between the ipsilateral transfer function and the contralateral transfer function in the virtual location to a subtraction between the ipsilateral transfer function and the contralateral transfer function in the actual speaker location;
a third adder to add a signal outputted from the first filter and a signal outputted from the second filter;
a fourth adder to subtract the signal outputted from the second filter from the signal outputted from the first filter;
a fifth adder to add a surround first direction channel signal to a signal outputted from the third adder;
a sixth adder to add a surround second channel signal to a signal outputted from the fourth adder; and
an Inverse Modified Discrete Cosine Transform (IMDCT) unit to receive a plurality of channel signals, a signal outputted from the fifth adder, and a signal outputted from the sixth adder, and to perform an IMDCT of the received signals.
